(19) United States
(12) Patent Application Publication
(10) Pub. No.: US 2005/0219594 A1
(43) Pub. Date: Oct. 6, 2005

(54) Apparatus and method for generating scanned data in a standard format

(76) Inventors: Isao Miyamoto, Kanagawa-ken (JP); Hiroyuki Kawamoto, Kanagawa-ken (JP); Hiroshi Arai, Saitama-ken (JP); Satoshi Ohkawa, Tokyo (JP); Takeharu Tone, Tokyo (JP); Naoki Sugiyama, Kanagawa-ken (JP); Taira Nishita, Tokyo (JP); Maki Ohyama, Tokyo (JP)

Correspondence Address: DICKSTEIN SHAPIRO MORIN & OSHINSKY LLP, 2101 L Street, NW, Washington, DC, 20037, US

(21) Appl. No.: 11/085,010

(22) Filed: Mar. 21, 2005

(30) Foreign Application Priority Data
Mar. 19, 2004 (JP) 2004-080635

(51) Int. Cl. G06F 15/00

(52) U.S. Cl. 358/1.13; 358/448

(57) ABSTRACT

The image processing apparatus includes a reader, a printer image generator, a storage device, and a data format converter. The reader reads an original image into original image data. The printer image generator generates printer image data corresponding to the original image data in a device specific format. The storage device stores the printer image data in the device specific format. The data format converter converts the printer image data from the device specific format to a standard format.

### CROSS-REFERENCE TO RELATED APPLICATIONS

This patent application is based on and claims priority to Japanese patent application No. JPAP2004-080635 filed on Mar. 19, 2004, in the Japanese Patent Office, the entire contents of which are hereby incorporated by reference.

### FIELD OF THE INVENTION

The present invention relates to an apparatus and method for image processing, capable of generating scanned data in a standard format.

### DESCRIPTION OF THE RELATED ART

Existing image forming apparatuses, such as digital copiers, store image data in memory. For example, a digital copier reads an original image into image data using a scanning function, and stores the scanned image data in its memory. To print out the image data, the digital copier reads out the scanned image data from the memory, and forms a toner image based on the scanned image data. With the image data being stored, the digital copier can reprint the original image, or it can rearrange the pages of the original image.

However, the digital copier stores the scanned image data in a device specific format to save memory space or to increase the image processing speed. This creates another problem when the digital copier is used in a network system.

For example, the digital copier sends the scanned image data to a personal computer via a network. In order to display or edit the scanned image data, the personal computer needs to convert the scanned image data from the device specific format to a format readable by the personal computer using a specific client software.

### BRIEF SUMMARY OF THE INVENTION

Exemplary embodiments of the present invention include an image processing apparatus, image processing method and computer program and product, each capable of generating scanned data in a standard format.

In one exemplary embodiment, the image processing apparatus includes a reader, a printer image generator, a storage device, and a data format converter. The reader reads an original image into original image data. The original image includes any kind of data, such as graphic data, character data, binary data, or mulitvalue data, for example. The printer image generator generates printer image data corresponding to the original image data in a device specific data format. The storage device stores the printer image data in the device specific data format. The data format converter converts the printer image data from the device specific data format to a standard data format. Once the printer image data is converted, the data format converter may send the converted image data to a network.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic block diagram illustrating an image processing apparatus according to an exemplary embodiment of the present invention;

FIG. 2 is a schematic block diagram illustrating a multifunctional apparatus according to an exemplary embodiment of the present invention;

FIG. 3 is a schematic block diagram illustrating a data format converter according to an exemplary embodiment of the present invention;

FIG. 4 is a schematic block diagram illustrating a data format converter according to an exemplary embodiment of the present invention;

FIG. 5 is a schematic block diagram illustrating the image processor shown in FIG. 4 according to an exemplary embodiment of the present invention;

FIG. 6 is a schematic block diagram illustrating a multifunctional apparatus according to an exemplary embodiment of the present invention;

FIG. 7 is a schematic block diagram illustrating the image processor shown in FIG. 4 according to an exemplary embodiment of the present invention; and

FIG. 8 is a schematic block diagram illustrating the image processor shown in FIG. 4 according to an exemplary embodiment of the present invention.

### DETAILED DESCRIPTION OF THE INVENTION

In describing the preferred embodiments illustrated in the drawings, specific terminology is employed for clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views.

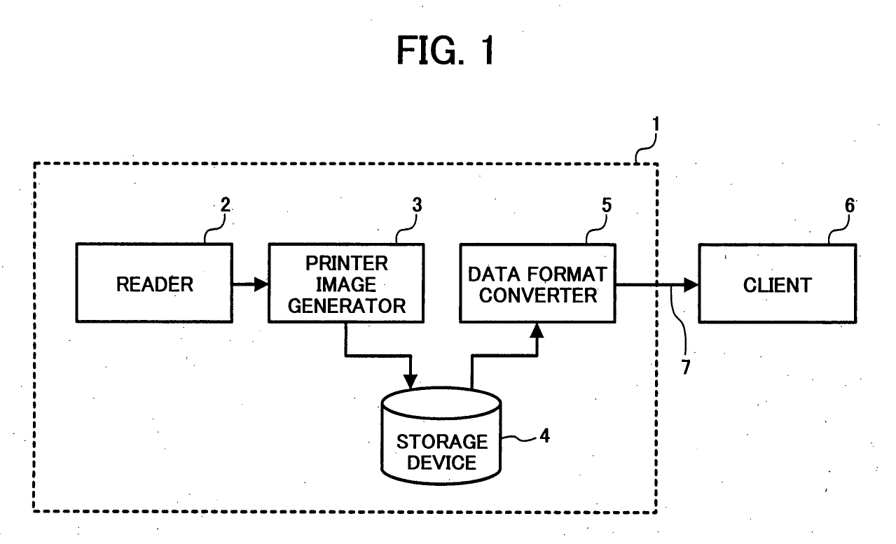

FIG. 1 illustrates an image processing apparatus 1 according to a preferred embodiment of the present invention.

The image processing apparatus 1 includes a reader 2, a printer image generator 3, a storage device 4, and a data format converter 5. The image processing apparatus 1, which is connected to a client 6 via a network 7, operates according to an instruction received from the client 6.

In an exemplary operation, the reader 2 reads an original image into original image data. The printer image generator 3 generates printer image data corresponding to the original image data in a device specific compression format. The storage device 4 stores the printer image data in the device specific compression format for future use.

If the client 6 instructs the image processing apparatus 1 to print the original image, the image processing apparatus 1 outputs the printer image data using a printer, which may be provided in the apparatus 1 or coupled to the apparatus 1. If the client 6 instructs the image processing apparatus 1 to send the original image data to the client 6, the data format converter 5 converts the printer image data from the device specific compression format to a standard compression format, and sends the converted printer image data to the client 6 via the network 7.

In this exemplary embodiment, the device specific compression format includes any kind of compression format previously defined by the image processing apparatus 1. The standard compression format includes any kind of compression format widely used.

In another exemplary operation, the reader 2 reads an original image into original image data. The printer image generator 3 generates printer image data corresponding to the original image data in a device specific file format. The storage device 4 stores the printer image data in the device specific file format for future use.

If the client 6 instructs the image processing apparatus 1 to print the original image, the image processing apparatus 1 outputs the printer image data using a printer, which may be provided in the image processing apparatus 1 or coupled to the image processing apparatus 1. If the client 6 instructs the image processing apparatus 1 to send the original image data to the client 6, the data format converter 5 converts the printer image data from the device specific file format to a standard file format, and sends the converted printer image data to the client 6 via the network 7.

In this exemplary embodiment, the device specific file format includes any kind of file format previously defined by the apparatus 1. The standard file format includes any kind of file format widely used in various devices.

In another exemplary operation, the reader 2 reads an original image into original image data in a first device specific color space. The printer image generator 3 generates printer image data corresponding to the original image data in a second specific device color space. The storage device 4 stores the printer image data in the second device specific color space for future use.

If the client 6 instructs the image processing apparatus 1 to print the original image, the image processing apparatus 1 outputs the printer image data using a printer, which may be provided in the image processing apparatus 1 or coupled to the image processing apparatus 1. If the client 6 instructs the image processing apparatus 1 to send the scanned original image data to the client 6, the data format converter 5 converts the printer image data from the device specific color space to a standard color space and sends the converted printer image data to the client 6 via the network 7.

In this exemplary embodiment, the first device specific color space includes any kind of color space previously defined by the reader 2, such as a color space based on a RGB model. The second device specific color space includes any kind of color space previously defined by the printer image generator 3, such as a color space based on CMYK model. The standard color space includes any kind of color space widely used.

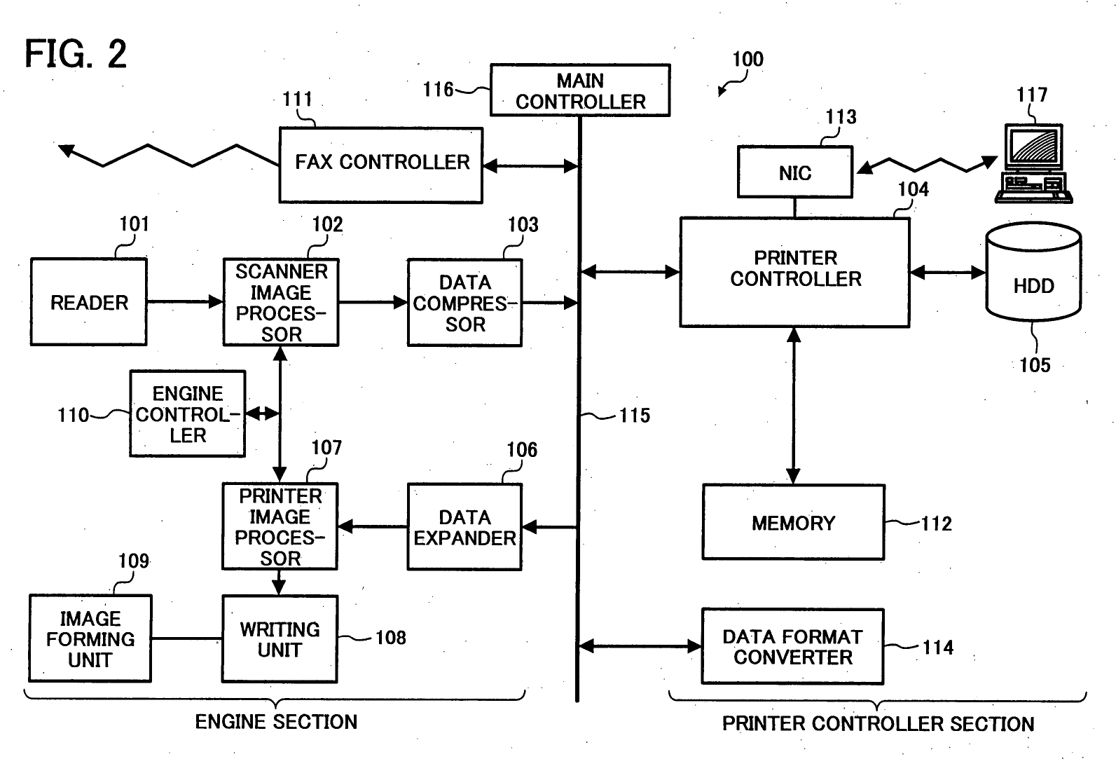

The image processing apparatus 1 of FIG. 1 may be implemented in various ways, for example, as a multifunctional apparatus 100 illustrated in FIG. 2. The multifunctional apparatus 100 stores an original image as image data in a device specific compression format and sends the image data in a standard compression format to a client 117 via a network.

As shown in FIG. 2, the multifunctional apparatus 100 includes an engine section, a printer controller section, and a main controller 116, which are connected to one another via a bus interface 115. The client 117 includes any kind of apparatus having a user interface, such as a personal computer as illustrated in FIG. 2, or an image processing apparatus provided with an operational panel, for example. The multifunctional apparatus 100 and the client 117 are connected to the network (e.g., LAN (local area network)).

The main controller 116 includes any kind of processor capable of controlling the operation of the multifunctional apparatus 100.

The engine section includes a fax controller 111, a reader 101, a scanner image processor 102, a data compressor 103, an engine controller 110, a data expander 106, a printer image processor 107, a writing unit 108, and an image forming unit 109.

The fax controller 111 controls transmission and reception of data with other apparatus through a public line. The reader 101 reads an original image into image data. The scanner image processor 102 applies scanner image processing to the image data received from the reader 101 (e.g., scanner gamma correction, filtering, or resolution conversion). The data compressor 103 compresses the processed image data to a device specific compression format. In this exemplary embodiment, the compressed image data is sent to the printer controller section via the bus interface 115, to be stored in a HDD 105 (hard disk drive).

The data expander 106 expands the compressed image data received from the printer controller section via the bus interface 115. The printer image processor 107 applies printer image processing to the expanded image data (e.g., printer gamma correction or halftone conversion). The writing unit 108 forms a latent image according to the image data received from the printer image processor 107. The image forming unit 109 forms a toner image according to the latent image.

The engine controller 110 includes any kind of processor, such as a CPU (central processing unit), capable of controlling the engine section.

The printer controller section includes an NIC (network interface controller) 113, a printer controller 104, the HDD 105, a memory 112, and a data format converter 114.

The NIC 113 controls data communication between the multifunctional apparatus 100 and other apparatuses, such as the client 117, for example, via the network.

The memory 112 may be implemented with any kind of memory which functions as a work area for the printer controller 104. The HDD 105 may be implemented with any kind of storage device or storage medium capable of storing various data, including image data received from the engine section, job history data, or an image processing program of the present invention, for example.

If the image processing program is previously stored in the HDD 105, the printer controller 104 loads the image processing program into the memory 112 to operate based on the image processing program. Alternatively, the image processing program may be downloaded via the network.

The data format converter 114 reads out the image data from the HDD 105 and applies format conversion to the image data before sending the image data to the client 117 via the network.

The printer controller 104 may be implemented with any kind of processor, such as a CPU, capable of controlling the printer controller section.

The multifunctional apparatus 100 performs at least one of the operations of faxing, copying, printing, or scanning according to a request received from the client 117.

The faxing operation includes receiving fax data from a sender apparatus, and storing the fax data in the HDD 105 for future use. The fax controller 111 expands the received image data, which has been compressed in a sender format specific to the sender apparatus, and sends the expanded image data to the printer controller 104 via the bus interface 115. The printer controller 104 stores the expanded image data in the memory 112, and further in the HDD 105 for future use. Before storing the image data, the printer controller 104 compresses the image data in a device specific compression format specific to the multifunctional apparatus 100. Other exemplary embodiments of the faxing operation are disclosed in U.S. Patent Application Publication No. 2004/0263884 ('884 Patent Publication) filed on May 5, 2004, the entire contents of which are hereby incorporated by reference.

The copying operation includes reading an original image into image data and printing the image data as a printed image. In the reading operation, the reader 101 reads an original image into image data. The scanner image processor 102 applies scanner image processing to the image data. The data compressor 103 compresses the processed image data to a device specific compression format that is specific to the multifunctional apparatus 100. The compressed image data is sent to the printer controller 104 via the bus interface 115. The printer controller 104 stores the compressed image data in the memory 112 and further in the HDD 105.

In the printing operation, the printer controller 104 reads out the compressed image data from the HDD 105 into the memory 112, and sends the data to the data expander 106 via the bus interface 115. The data expander 106 expands the compressed image data. The printer image processor 107 applies printer image processing to the expanded image data. The processed image data is printed out as a printed image using the writing unit 108 and the image forming unit 109. Other exemplary embodiments of the copying operation are disclosed in U.S. Patent Application Publication No. 2004/0114172 ('172 Patent Publication) filed on Sep. 24, 2003, the entire contents of which are hereby incorporated by reference.

The printing operation includes printing image data, received from the client 117, as a printed image. The printer controller 104 receives image data from the client 117 and stores the data in the memory 112. At this time, the printer controller 104 preferably compresses the received image data into a device specific compression format and stores the compressed image data in the HDD 105. The image data is then printed out as a printed image using the writing unit 108 and the image forming unit 109, as described above in the copying operation.

The scanning operation includes reading an original image into image data and sending the image data to the client 117. The reading operation is similar to the reading operation described above in the copying operation. In the sending operation, the printer controller 104 reads out the image data, which has been compressed in a device specific compression format, from the HDD 105 into the memory 112. The image data is sent to the data format converter 114 via the bus interface 115. The data format converter 114 expands the compressed image data and compresses the expanded image data into a standard compression format. The compressed image data is then sent to the client 117 via the NIC 113 and the network.

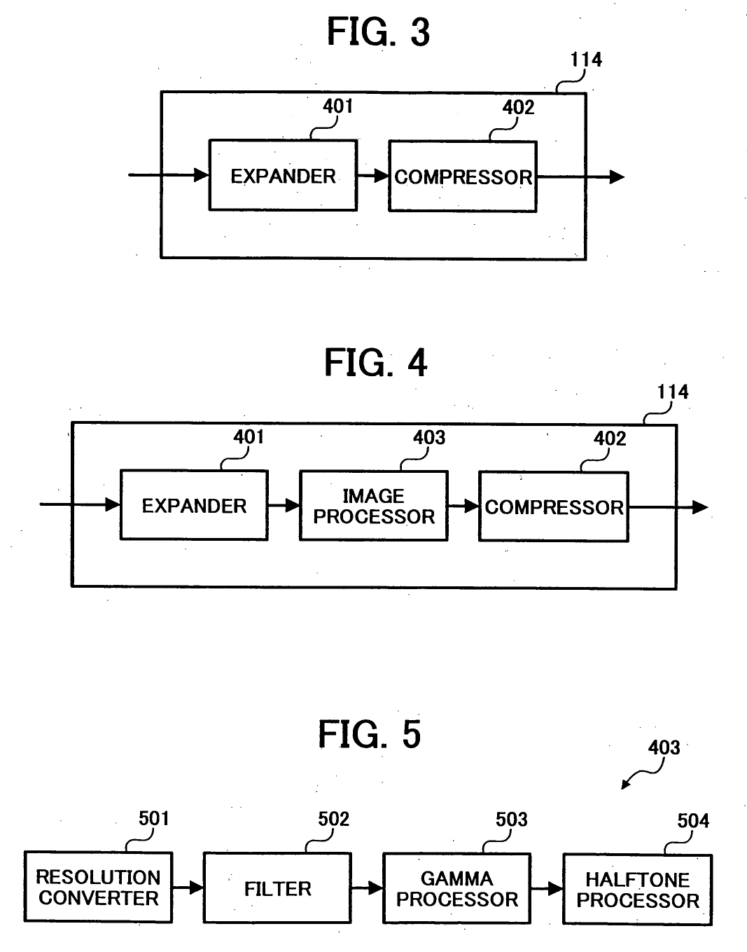

Referring to FIG. 3, an exemplary data format converter 114 is now described.

The data format converter 114 includes an expander 401 and a compressor 402. The expander 401 expands image data, which has been compressed by the data compressor 103 or the printer controller 104, and sends the expanded image data to the compressor 402. The compressor 402 compresses the expanded image data in a standard compression format.

For example, binary or multivalue image data has been compressed to a device specific compression format. The expander 401 expands the compressed image data, and sends the expanded image data to the compressor 402. The compressor 402 compresses the expanded image data in a standard compression format. For example, binary image data is compressed to MH, MR, or MMR and multivalue data is compressed to JPEG or JPEG 2000.

Referring now to FIG. 4, another exemplary data format converter 114 is now described. The data format converter 114 of FIG. 4 includes an image processor 403 in addition to the expander 401 and the compressor 402.

The image processor 403 applies image processing to the expanded image data received from the expander 401. Referring to FIG. 5, the image processor 403 may include a resolution converter 501, a filter 502, a gamma processor 503, and a halftone processor 504.

In an exemplary operation, the reader 101 reads an original image into image data at 600 dpi. The image data is stored in the HDD 105 after being processed and compressed. The compressed image data is sent to the data format converter 114 for format conversion. The expander 401 expands the compressed image data and sends the expanded image data to the image processor 403. The resolution converter 501 converts the resolution of the image data from 600 dpi to 300 dpi. The filter 502 applies filtering to the image data using a modulation transfer function, for example. The gamma processor 503 applies gamma conversion to change the density characteristics of the image data. The halftone processor 504 applies halftone processing to the image data.

The processed 300 dpi image data is then output to the compressor 402 to be converted to a standard compression format, and sent the client 117 via the NIC 113 and the network.

In addition to the above-described function, the multifunctional apparatus 100 of FIG. 2 may also store an original image as image data in a device specific file format and send the image data, in a standard file format, to the client 117 via the network.

In an exemplary operation, image data has been generated in a device specific file format. The data format converter 114 converts the image data from the device specific file format, such as JFIF (JPEG file interchange format), to a standard file format, such as TIFF.

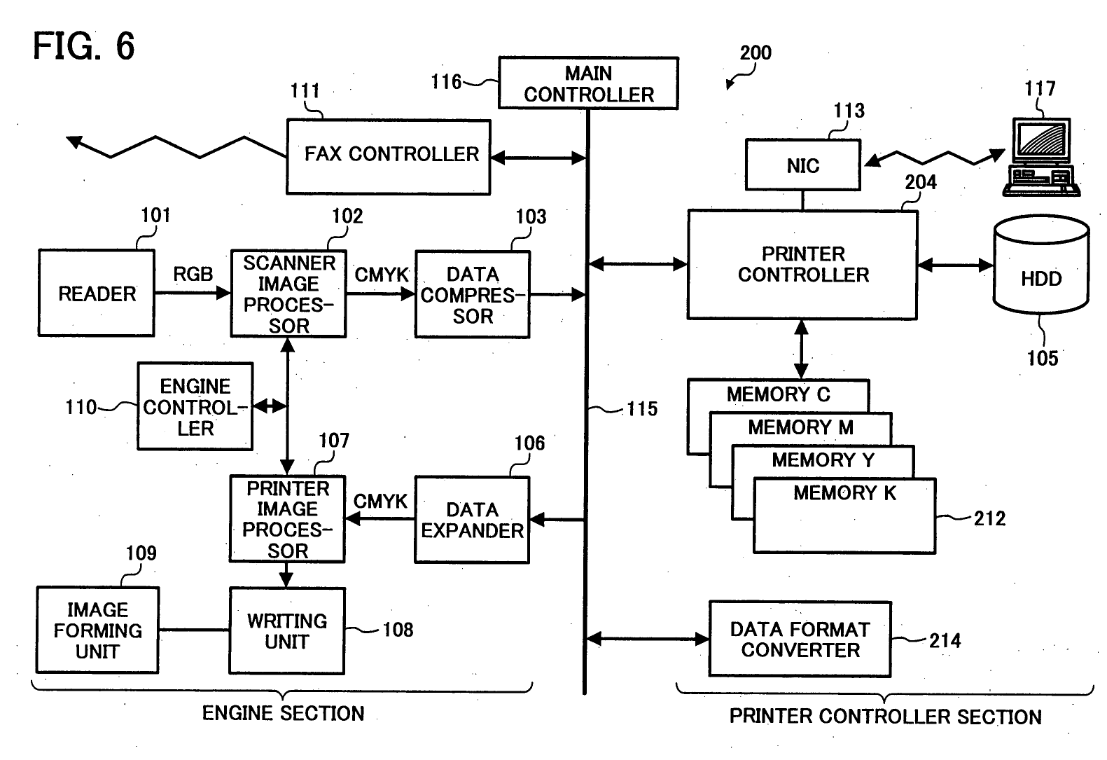

Referring now to FIG. 6, a multifunctional apparatus 200 is explained according to another preferred embodiment of the present invention.

The multifunctional apparatus 200 is substantially similar in structure to the multifunctional apparatus 100 illustrated in FIG. 2. The differences include the printer controller 204, the memory 212, and the data format converter 214.

In addition to the compression or file format conversion functions described above referring to FIG. 2, the apparatus 200 stores an original image as image data in a device specific color space and sends the image data in a standard color space to the client 117 via the network.

In an exemplary operation, the reader 101 reads an original color image into image data in a device specific RGB color space. The scanner image processor 102 applies scanner image processing to the image data and converts the image data from the RGB color space to a device specific CMYK color space. The data compressor 103 preferably compresses the processed image data in a device specific compression format that is specific to the apparatus 200. The compressed image data is sent to the printer controller 204 via the bus interface 115. The printer controller 204 stores the compressed image data in the memory 212. In this exemplary embodiment, the memory 212 stores each of the color components C, M, Y and K separately from one another. The printer controller 204 stores the image data in the HDD 105.

In the sending operation, the printer controller 204 reads out the compressed image data from the HDD 105 into the memory 212, and sends it to the data format converter 214 via the bus interface 115. The data format converter 214 converts the image data from the CMYK color space to a standard color space based on the RGB model, such as sRGB or LAB. The converted image data is then sent to the client 117 via the NIC 113 and the network.

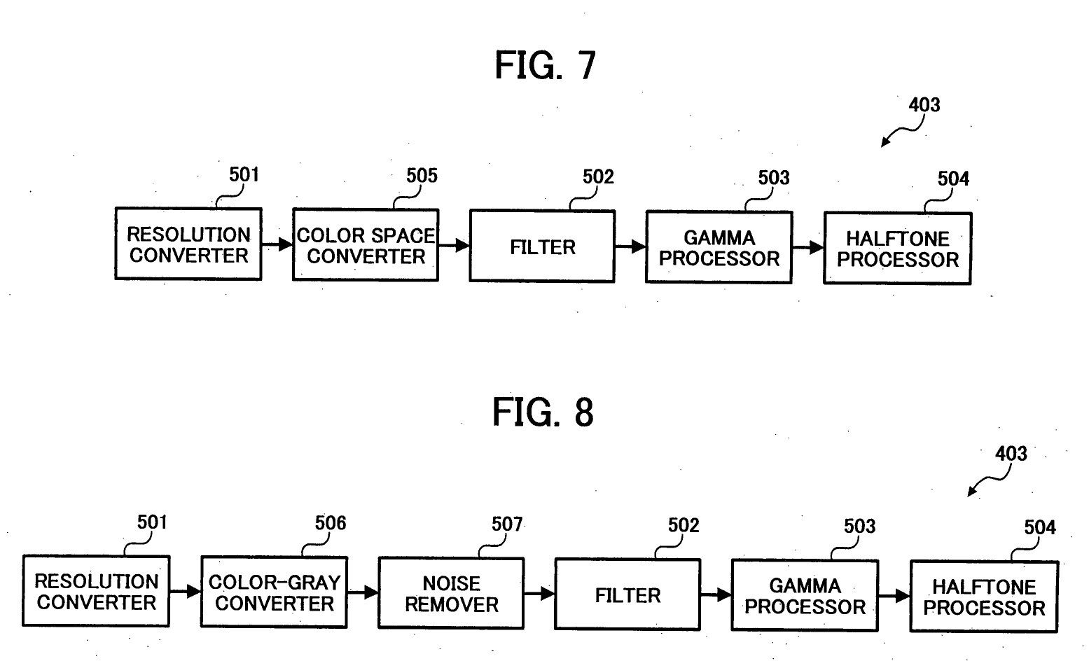

The data format converter 214 of FIG. 6 is substantially similar in to the data format converter 114 of FIG. 4. However, the image processor 403, FIG. 7, includes at least a color space converter 505 capable of converting color space.

FIG. 7 illustrates an exemplary image processor 403 according to this exemplary embodiment. The image processor 403 includes the resolution converter 501, the color space converter 505, the filter 502, the gamma processor 503, and the halftone processor 504.

In an exemplary operation, the reader 101 reads an original color image into image data at 600 dpi. The image data is stored in the HDD 105 after being processed and compressed. The compressed image data is sent to the data format converter 214 for conversion. The expander 401 expands the compressed image data, and sends the expanded image data to the image processor 403. The resolution converter 501 converts the resolution of the image data from 600 dpi to 300 dpi, for example. The color space converter 505 converts the image data from the CMYK color space to a standard color space. The filter 502 applies filtering to the image data by using a modulation transfer function, for example. The gamma processor 503 applies gamma conversion to change the density characteristics of the image data. The halftone processor 504 applies halftone processing to the image data. The processed 300 dpi image data is then output to the compressor 402 to be compressed into a standard compression format, and sent to the client 117 via the NIC 113 and the network.

In this exemplary embodiment, any kind of color conversion method may be applied, such as the table interpolation method disclosed in the '172 Patent Publication.

Further, the color space converter 505 may be able to convert color spaces other than the RGB or the CMYK color spaces.

For example, as illustrated in FIG. 8, the CMYK color space may be converted to a RGB color space, and further to a grayscale space. The image processor 403 of FIG. 8 includes the resolution converter 501, the color-gray converter 506, the noise remover 507, the filter 502, the gamma processor 503, and the halftone processor 504.

In an exemplary operation, the reader 101 reads an original color image into image data at 600 dpi. The image data is stored in the HDD 105 after being processed and compressed. The compressed image data is sent to the data format converter 214 for conversion. The expander 401 expands the compressed image data and sends the expanded image data to the image processor 403. The resolution converter 501 converts the resolution of the image data from 600 dpi to 300 dpi, for example. The color-gray converter 506 converts the image data from the CMYK color space to a grayscale space via a RGB color space. The noise remover 507 suppresses noise in the image data. The filter 502 applies filtering to the image data by using a modulation transfer function, for example. The gamma processor 503 applies gamma conversion to change the density characteristics of the image data. The halftone processor 504 applies halftone processing to the image data. The processed 300 dpi image data is then output to the compressor 402 to be compressed into a standard compression format. After compression is complete, the data is sent to the client 117 via the NIC 113 and the network.

In this exemplary embodiment, any kind of noise suppression methods may be applied. For example, the isolated point removing method disclosed in the '884 Patent Publication may be applied.

Numerous additional modifications and variations are possible in light of the above teachings. It is therefore to be understood that within the scope of the appended claims, the disclosure of this patent specification may be practiced other than those specifically described herein.

Further, in this exemplary embodiment, the multifunctional apparatus 200 reads an original color image, however, the apparatus 200 may be able to read a monochrome image and generate image data in a grayscale color space, for example.

For example, in addition to the above-described exemplary image processing operations, the image processor 403 of FIG. 4 may perform other image processing operations as disclosed in either of the '172 patent Publication or '884 Patent Publication.

Further, an image processing operation performed by the data format converter in any one of the above-described exemplary embodiments may be performed by the data compressor 103 and the data expander 106, or by the printer controller 104 or 204.

Furthermore, elements and/or features of different illustrative embodiments may be combined with each other and/or substituted for each other within the scope of this disclosure and appended claims. For example, the image processing apparatus of the present invention may perform all of the functions including the compression form at conversion, the file format conversion, and the color space conversion, or it may perform at least one of the functions.

1. An image processing apparatus, comprising:
a reader configured to read an original image into original image data;
a printer image generator configured to generate printer image data, corresponding to the original image data, in device specific format;
a storage device configured to store the printer image data in the device specific format; and
a data format converter configured to convert the printer image data from the device specific format to a standard format.

2. The apparatus of claim 1, wherein the device specific format includes a device specific compression format, and the standard format includes a standard compression format.

3. The apparatus of claim 2, wherein the data format converter further comprises:
an expander configured to expand the printer image data in the device specific format; and
a compressor for compressing the expanded printer image data into the standard compression format.

4. The apparatus of claim 2, wherein the data format converter further comprises:
an expander configured to expand the printer image data in the device specific compression format;
an image processor configured to apply image processing to the expanded printer image data; and
a compressor configured to compress the processed printer image data in the standard compression format.

5. The apparatus of claim 1, wherein the device specific format includes a device specific file format, and the standard data format includes a standard file format.

6. The apparatus of claim 1, wherein the device specific format includes a device specific color space, and the standard data format includes a standard color space.

7. The apparatus of claim 6, the data format converter further comprises:
a color space converter configured to convert the printer image data from the device-specific color space to the standard color space.

8. The apparatus of claim 6, wherein the device specific format further includes a device specific compression format, and the standard format further includes a standard compression format.

9. The apparatus of claim 8, wherein the data format converter further comprises:
an expander configured to expand the device specific compression of the printer image data;
a color space converter configured to convert the expanded printer image data from the device specific color space to the standard color space; and
a compressor configured to compress the converted printer image data in the standard compression format.

10. The apparatus of claim 1, wherein the device specific format includes a color space based on a CMYK model, and the standard format includes a standard color space based on an RGB model.

11. The apparatus of claim 1, wherein the device specific format includes a color space based on a CMYK model, and the standard format includes a grayscale space.

12. The image processing apparatus of claim 1, further comprising:
a sender for sending the printer image data, in the standard format, to an output device via a network.

13. The image processing apparatus of claim 1, wherein the data format converter is configured to further convert the printer image data from the standard format to a format specified by an output device.

14. The image processing apparatus of claim 13, further comprising:
a sender configured to send the printer image data in the specified format to the output device via a network.

15. An image processing apparatus, comprising:
a processor;
a storage device configured to store a plurality of instructions which, when activated by the processor, cause the processor to perform an image processing operation comprising:
reading an original into original image data;
generating printer image data corresponding to the original image data in a first format;
storing the printer image data in the first format;
converting the printer image data from the first format to a second format; and
sending the printer image data in the second format to an output device via a network.

16. The apparatus of claim 15, wherein the image processing operation further comprises:
applying image processing to the printer image data, with the processed image data being sent to the output device.

17. A computer readable medium storing computer instructions for performing image processing operating comprising:
reading an original image into original image data in a first format;
generating printer image data corresponding to the original image data in a second format;
storing the printer image data in the second format;
converting the printer image data from the second format to a third format; and
sending the printer image data in the third format to an output device via a network.

18. An image processing method comprising:
storing scanned image data in a device specific format;
converting the scanned image data from the device specific format to a standard format; and
sending the scanned image data in the standard format to a network.

19. An image processing apparatus, comprising:
means for reading an original image into original image data;
means for generating printer image data corresponding to the original image data, in a device specific format;
means for storing the printer image data in the device specific format; and
means for converting the printer image data from the device specific format to a standard format.

20. The apparatus of claim 19, further comprising:
means for generating a printed image corresponding to the printer image data.

21. The apparatus of claim 20, wherein the converting means and the printed image generating means are incorporated into one device.
